(19) United States
(12) Patent Application Publication
(10) Pub. No.: US 2004/0074399 A1
(43) Pub. Date: Apr. 22, 2004

(54) Food service cart assembly

(76) Inventors: Chunnan Zhou, Northbrook, IL (US); Mark D. Bauer, Mount Prospect, IL (US); Kenneth H. Dorman, Carol Stream, IL (US); Sean J. Brady, Milwaukee, WI (US); Tim P. Murray, Menomonee Falls, WI (US); Joe A. Burns, Keller, TX (US)

Correspondence Address: Raymond W. Campbell, TAYLOR & AUST, P.C., 142 S. Main St., P.O. Box 560, Avilla, IN, 46710, US

(21) Appl. No.: 10/272,706

(22) Filed: Oct. 17, 2002

(51) Int. Cl. A47J 9/00

(52) U.S. Cl. 99/448; 99/467

(57) ABSTRACT

A food service cart assembly having improved panel structures and an improved divider and tray arrangement to increase the thermal insulation efficiency of the assembly. Several different panel structures are disclosed, to reduce thermal transfer between the inside and outside surfaces, and between the inside surfaces in the separate heated and refrigerated compartments of the cart. The divider and food trays reduce airflow and thermal transfer between the heated and refrigerated compartment.

### FIELD OF THE INVENTION

The present invention generally relates to food service cart assemblies, and, more particularly, to the insulating structures, including the panels forming the walls, top and bottom, and interior dividers for food service carts having heated and refrigerated compartments.

### BACKGROUND OF THE INVENTION

In institutional settings such as hospitals, nursing homes and the like it is necessary to serve a large number of meals in a relatively short period of time. Similar food serving circumstances can be experienced in social gatherings such as banquets and other events during which a meal is served. In most such circumstances, it is impractical to prepare and serve the food dishes immediately. Therefore, it is known for the food items to be prepared well in advance of the intended mealtime. In some smaller settings, and with sufficient servers, the food items can be held in bulk quantities until the meal is to be served, at which time the individual portions are plated and served immediately.

However, in large institutional settings such as hospitals and the like the kitchen and plating areas can be distant from the serving area. In hospitals, for example, the meals are served in the individual patient rooms. In these situations it becomes impractical to plate and serve the meals at the same time. Therefore, it is known to plate each portion in a preparation area, and to then transport the plated meals to the serving area. Food service carts have been used for this purpose. The carts are provided with shelving systems, and the meals are placed on trays held in the shelving system.

It is common for meals to include both hot and cold foods. Health and safety standards require that hot items be maintained at specific minimum temperatures, and that cold items be maintained below other specific maximum temperatures. Not only are improperly stored foods less appetizing and less palatable, spoilage of the food can occur rapidly if the food is not stored properly.

Maintaining the hot and cold items in separate carts or containers, and combining the individual servings on a service setting just prior to service overcomes the food quality and storage concerns, but has the detrimental aspect of substantially increasing the time required for serving the meal.

It is known to provide food service carts having both a heated side and a refrigerated side, with a thermal barrier therebetween. Meals are assembled on trays, with all hot items on one side of the tray and all cold items on the other side of the tray. The tray is designed to fit in the food service cart with all the hot items in the heated portion of the cart and all the cold items in the refrigerated portion of the cart. The thermal barrier separates the items on each tray.

Food service carts having both heated and refrigerated sections allow entire meals to be assembled on a tray, stand for an extended period of time and served quickly. The efficiency of such a cart is affected by the effectiveness of the structure in isolating the heated and refrigerated sections from each other, and from the ambient environment. There is a continuing need to reduce thermal transmission from the heated to the refrigerated sections, from the heated section to the outside and from the outside to the refrigerated section. It is also necessary that the food service cart be cleaned easily inside and out. Stainless steel is a preferred material for its easy cleanability. Unfortunately, stainless steel is a relatively good thermal conductor, further complicating the efforts to provide thermal isolation of the heated and refrigerated compartments. Even if the hollow cavity of a food cart wall is insulated, heat can be lost to the refrigerated side via conduction along the inner surface of the wall.

What is needed is an improved isolation structure segregating the heated and refrigerated sections from each other and from the ambient environment.

### SUMMARY OF THE INVENTION

The present invention provides a food service cart assembly having improved wall structures and an improved divider and tray system to increase the thermal efficiency of the assembly by reducing thermal transfer between the inside and outside surfaces, and between the inside surfaces of the separate heated and refrigerated areas of the cart.

In one aspect thereof, the present invention provides a food service cart assembly with a plurality of panels including a top, a bottom and sides defining an interior space. The interior space includes first and second compartments controllable to different environmental conditions. Each of the panels has an inner panel piece and an outer panel piece structured and arranged to limit physical contact between the respective inner panel piece and outer panel piece of the panel. Panels that span the first and second compartments have discontinuous inner panel pieces. A core in the interior space includes a shelving system for supporting food trays, and a divider separating the first and second compartments. The divider defines slots for receiving trays, the slots being shaped for retarding the flow of air from one side of the divider to the other side of the divider.

In another aspect thereof, the present invention provides a core for a food service cart assembly having heated and refrigerated compartments. The core has a shelving system for supporting food trays; food trays supported by the shelving system; and a divider defining slots for receiving trays. The slots are shaped for limiting the flow of air from one side of the divider to the other side of the divider.

In a further aspect thereof, the present invention provides a panel for at least one of a top, bottom, sides and a door of a food service cart having heated and refrigerated compartments therein. The panel has an inner panel piece and an outer panel piece structured and arranged to limit direct physical contact between them. Insulation is disposed between adjacent surfaces of the inner panel piece and the outer panel piece.

In a still further aspect thereof, the present invention provides a food tray for a food service cart assembly with a first food compartment, a second food compartment and a bridge between the first food compartment and the second food compartment. The bridge includes a first bridge segment and a second bridge segment connected to the first food compartment and the second food compartment, respectively. The first bridge segment and the second bridge segment define substantially horizontal components at a first elevation. A third bridge segment is at a second elevation different from the first elevation. A first tying segment interconnects the first bridge segment and the third bridge segment, and a second tying segment interconnects the second bridge segment and the third bridge segment.

An advantage of the present invention is providing a food service cart assembly that reduces heat transfer between the heated and refrigerated sections of the cart.

Another advantage of the present invention is providing a food service cart assembly that reduces heat transfer between the ambient environment and the interior of the cart.

Yet another advantage of the present invention is providing a food service cart assembly having easily cleaned surfaces.

A still further advantage of the present invention is providing a food service cart assembly with structure for improved thermal isolation of the heated and refrigerated sections in a cost efficient manner.

Yet another advantage of the present invention is providing a food service cart that minimizes airflow between the refrigerated and heated sections.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a food service cart assembly according to the present invention;

FIG. 2 is a perspective view of a first embodiment of an inner core of the food service cart assembly shown in FIG. 1;

FIG. 3 is an elevational view of the inner core shown in FIG. 2;

FIG. 4 is a perspective view of one component of a center divider in the inner core shown in FIG. 3;

FIG. 5 is a perspective view of a serving tray used with the food service cart assembly shown in the previous Figures;

FIG. 6 is a perspective view of a second embodiment for the center divider, the divider being shown with a tray inserted therein;

FIG. 7 is an enlarged, fragmentary, perspective view of the center divider shown in FIG. 6;

FIG. 8 is a perspective view of a first embodiment for a cart panel according to the present invention;

FIG. 9 is a perspective view of one inner panel piece of the panel shown in FIG. 8;

FIG. 10 is a perspective view of another embodiment of a cart panel according to the present invention; and

FIG. 11 is an enlarged cross sectional view of still another embodiment for a cart panel in accordance with the present invention.

Before the embodiments of the invention are explained in detail, it is to be understood that the invention is not limited in its application to the details of construction and the arrangements of the components set forth in the following description, or illustrated in the drawings. The invention is capable of other embodiments and of being practiced or being carried out in various ways. Also, it is understood that the phraseology and terminology used herein are for the purpose of description, and should not be regarded as limiting. The use herein of “including” and “comprising” and variations thereof is meant to encompass the items listed thereafter and equivalents thereof, as well as additional items and equivalents thereof.

### DETAILED DESCRIPTION OF THE PREFERRED EMBODIMENT

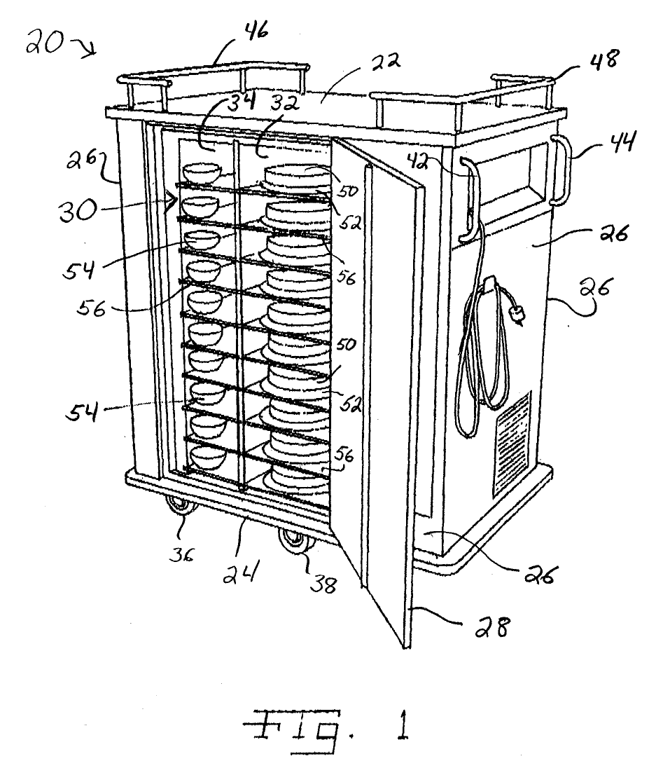

Referring now more specifically to the drawings, and to FIG. 1 in particular, numeral 20 designates a food service cart assembly embodying the present invention. Cart assembly 20 includes a plurality of panels 22, 24, 26 and 28, including a top panel 22, a bottom panel 24, a side panel 26 and a door panel 28 cooperatively defining an interior space 30. Panels 22, 24, 26 and 28 thereby define an environmentally controlled interior space 30 that is divided into separate compartments 32, 34 including a heated compartment 32 and a refrigerated compartment 34.

A plurality of casters 36, 38 are provided beneath bottom panel 24, so that cart assembly 20 can be moved from a food preparation area to a storage area and to a food service area as necessary. While only two casters 36, 38 are visible in FIG. 1, it should be understood that cart assembly 20 will commonly include three or four casters.

Food service cart assembly 20 further includes a refrigeration/heating unit (not shown) to provide heat for heated compartment 32, and to cool refrigerated compartment 34. An electrical connection 40 is provided by which the heating and cooling units (not shown) can be connected to an electrical power source.

Cart assembly 20 may be provided with handles 42, 44 on one or more of side panels 26 for providing a grip by which cart assembly 20 can be pushed or pulled as necessary to move cart assembly 20 where desired. Further, rails 46 and 48 are provided on top panel 22 so that food covers 50 from plates 52 or other items can be stacked securely on top panel 22 as service of the meals occurs. For clarity of the drawings some, but not all of food covers 50 and plates 52 are designated with the reference numerals in FIG. 1. Further, FIG. 1 illustrates a plurality of bowls 54 in refrigerated compartment 34. Again, some, but not all bowls 54 are designated with the reference numeral 54 in FIG. 1. Plates 52 and bowls 54 are provided on trays 56, each tray 56 holding an individual meal that may include one or more container such as plates 52 and bowls 54 with hot and cold food therein. Some, but not all trays 56 are designated with the numeral 56 in FIG. 1.

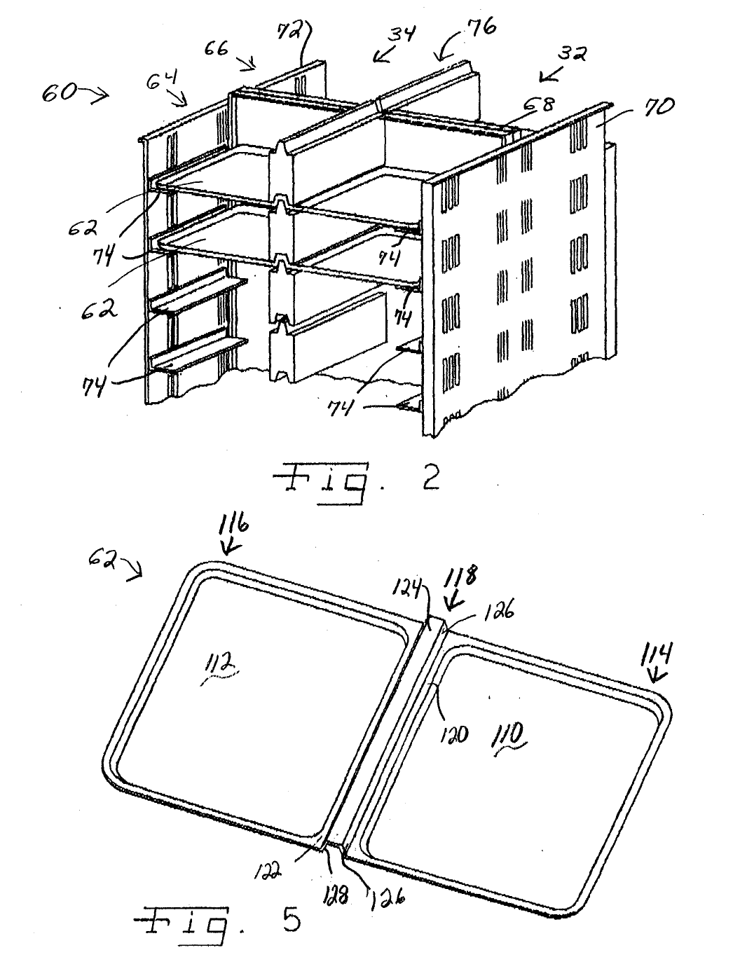

Interior space 30 is provided with a core 60 (FIG. 2) that defines and separates interior space 30 into heated compartment 32 and refrigerated compartment 34. Core 60 provides a support means for the plurality of food service trays on which the meals are served. A preferred food service tray 62, to be described in further detail hereinafter, is illustrated in FIGS. 2, 3 and 5.

As can be seen most clearly from FIG. 2, food service cart assembly 20 is fitted with opposed storage sections so that meals may be served from opposite sides of cart assembly 20. Accordingly, a first service side 64 is depicted in the foreground of FIG. 2 and a second service side 66 is depicted in the background of FIG. 2. It should be understood that each heated compartment 32 and refrigerated compartment 34 extends between both first surface side 64 and second surface side 66 of food service cart assembly 20. A separator 68 segregates first service side 64 from second side service side 66.

Support walls 70 and 72 are provided at opposite ends of separator 68. Support walls 70 and 72 extend between first service side 64 and second side service side 66. Each support wall 70 and support wall 72 includes a plurality of tray supports 74 in both first service side 64 and second service side 66. Each tray support 74 of support wall 70 is generally aligned with an opposed tray support 74 on support wall 72, such that a food service tray 62 can be supported in substantially level orientation between support wall 70 and support wall 72.

To separate heated compartment 32 from refrigerated compartment 34 on each first service side 64 and second service side 66, core 60 is provided with a divider 76 structured to limit airflow from one side of divider 76 to the other side thereof. Divider 76 defines a shaped slot 78 for each food service tray 62. The shaped slots 78 cooperate with the structure and shape of food service trays 62 to both support trays 62 and further limit air flow from one side of divider 76 to the other side of divider 76.

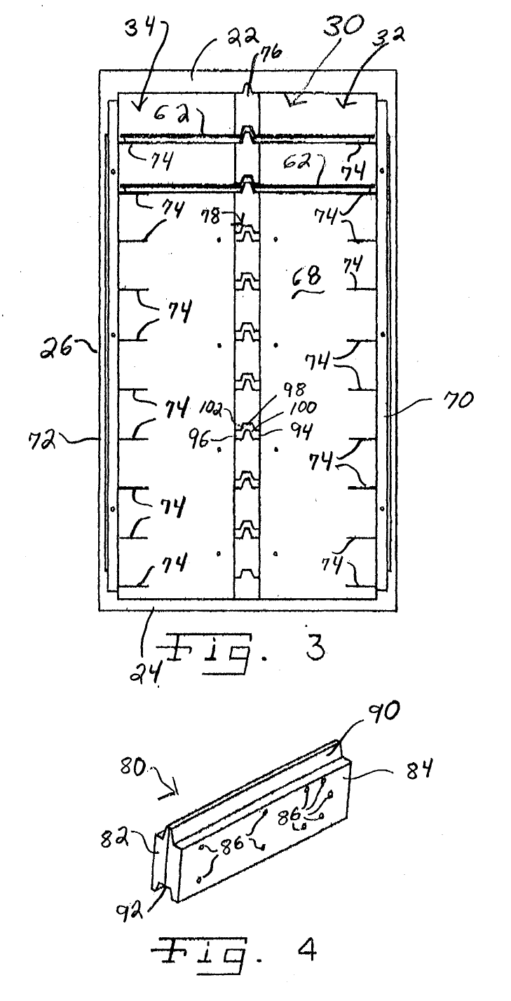

Divider 76, in a preferred embodiment, is formed of a plurality of individual components 80 (FIG. 4) mounted on and supported by separator 68 and anchored to top panel 22 and bottom panel 24, to provide a thermal and airflow barrier between heated compartment 32 and refrigerated compartment 34. In a preferred structure for components 80, which provides easy manufacturability, identical component halves 82 and 84 are provided, secured to each other by a plurality of fasteners 86, that may be screws, bolts, rivets or other fasteners. Adhesive also may be used between component halves 82 and 84. Components 80 have complementary top and bottom structures 90 and 92, respectively, such that two components 80 placed in minimally spaced proximity define slot 78 therebetween. Thus, each top 90 is a generally domed shaped structure and each bottom 92 defines a channel.

As can be seen most clearly in the elevational view of FIG. 3, each slot 78 thereby includes first and second substantially horizontal slot segments 94 and 96 communicating with heated compartment 32 and refrigerated compartment 34, respectively. First and second substantially horizontal slot segments 94 and 96 are each at a first substantially similar elevation. A third substantially horizontal slot segment 98 is provided generally between first slot segment 94 and second slot segment 98. Third horizontal slot segment 98 is provided at a second elevation. In the exemplary embodiment of FIG. 3, the second elevation defined by third slot segment 98 is higher than the first elevation of first and second slot segments 94 and 96. A first interconnecting slot segment is disposed between first slot segment 94 and third slot segment 98, and a second interconnecting slot segment 102 is provided between second slot segment 96 and third slot segment 98. All slots 78 are similarly shaped; however, for purposes of drawing clarity, in FIG. 3 only one slot 78 has been identified with slot segments 94, 96, 98, 100 and 102.

It should be understood that while the exemplary embodiment shown illustrates third horizontal slot segment 98 to be higher than first and second horizontal slot segments 94 and 96, the reverse arrangement could also be used. First and second horizontal slot segments 94 and 96 could be provided at a first elevation higher than a second elevation of third horizontal slot segment 98.

Food service trays 62 are provided of a design to cooperate with slot 78, further limiting the flow of air between heated compartment 32 and refrigerated compartment 34, and allowing trays 62 to be supported at the middle thereof by divider 76.

As can be seen most clearly in FIG. 5, each food service tray 62 has a first food compartment 110 and a second food compartment 112 on which hot and cold foods, respectively, can be served. Compartments 110 and 112 are wells in which various containers, such as plates 52 and bowls 54 can be placed. Outer edges 114 and 116, respectively, of first and second food compartments 110 and 112, respectively, are supported on tray supports 74 of first support wall 70 and second support wall 72, respectively. A bridge 118 connects first food compartment 110 and second food compartment 112, and is shaped to slide into slot 78. To this end, bridge 118 includes first and second lateral portions 120 and 122, an upper bridge portion 124 and interconnecting bridge portions 126 and 128 between the first and third and second and third bridge portions, respectively.

With a tray 62 loaded in each slot 78, airflow is substantially prevented between heated compartment 32 and refrigerated compartment 34. Even without a tray 62 loaded therein, the narrowness of each slot 78 and the convoluted path defined thereby substantially limits the flow of air through slot 78.

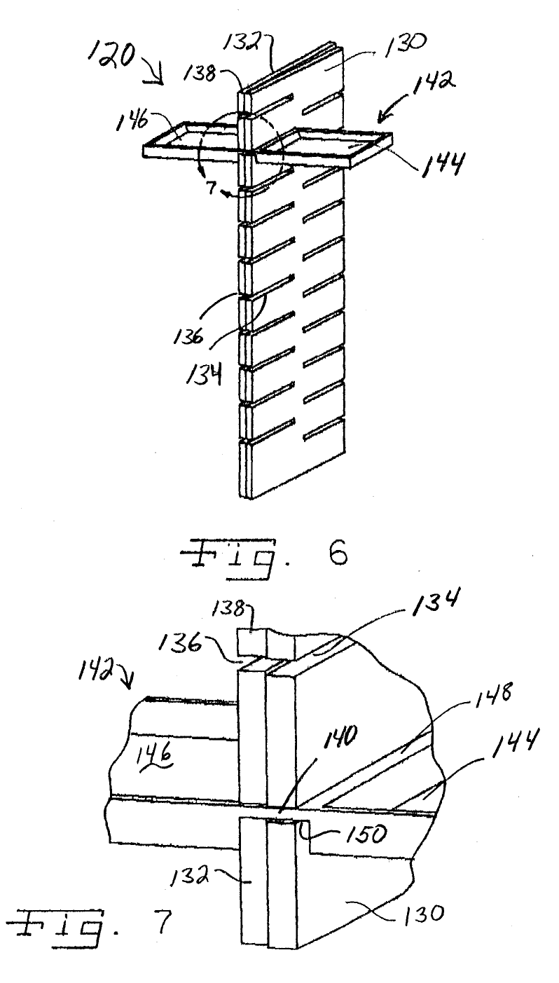

FIGS. 6 and 7 illustrate a second embodiment 120 for the divider. First and second divider wall segments 130 and 132 are provided adjacent each other. Each divider wall segment 130 and 132 includes a plurality of slots 134 and 136, respectively, extending rearward from a forward edge 138 thereof. Slots 134 and 136 are sized to receive a bridge 140 of a food service tray 142. Bridge 140 is a substantially linear body extending between food compartments 144 and 146 of tray 142.

While trays 142 are being loaded into cart assembly 20 having divider 120, first and second walls segments 130 and 132 are positioned in substantial alignment with each other such that slots 134 and 136 are aligned. Bridges 140 of trays 142 slide easily into aligned slots 134 and 136. After all necessary trays have been loaded in food service cart assembly 20, at least one of first and second wall segments 130 and 132 is moved either upwardly or downwardly relative to the other wall segment. Alternatively, each may be movable, but in opposite directions. After the movement of one or both wall segments 130, 132 has been completed, the alignment of adjacent slots 134 and 136 with bridge 140 of tray 142 loaded therein is as illustrated in FIG. 7. If the relative movement of wall segments 130 and 132 lowers first wall segment 130 relative to second wall segment 132, slot 134 engages against a top 148 of bridge 140, and slot 136 engages against a bottom 150 of bridge 140. If the relative movement of wall segments 130 and 132 elevates first wall segment 130 relative to second wall segment 132, slot 134 engages against bottom 150 of bridge 140, and slot 136 engages against a top 148 of bridge 140. Engagement of the respective wall segments 130 and 132 against top 148 and bottom 150 of bridge 140 substantially inhibits the transfer of heat and airflow between heated compartment 32 and refrigerated compartment 34.

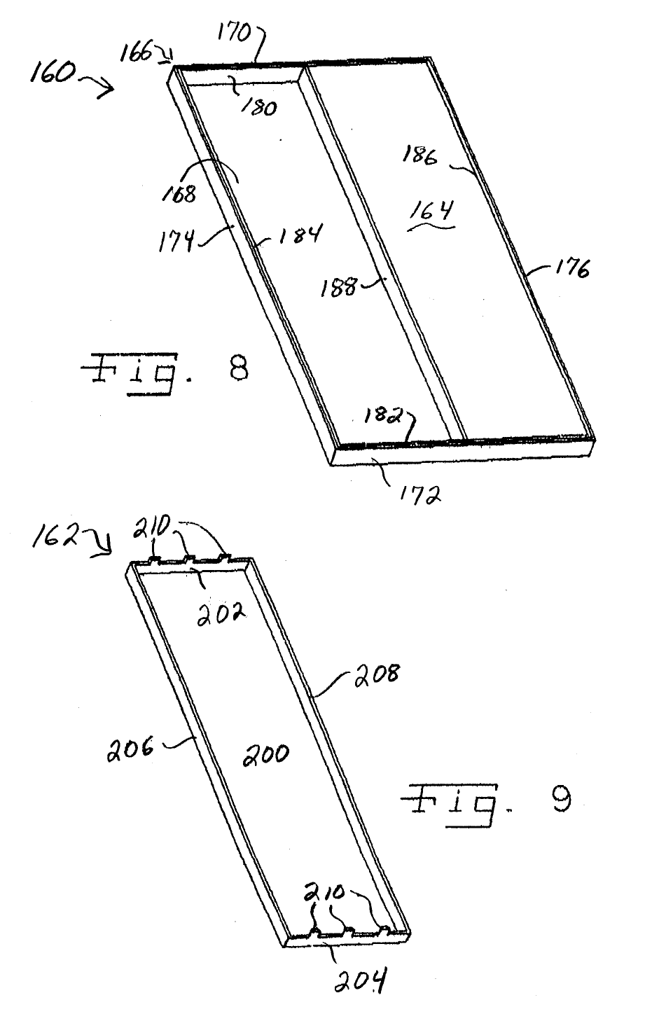

It has been known to fill the various panels 22, 24, 26 and 28 of a food service cart assembly 20 with insulation to minimize heat transfer. However, it is also common to manufacture the inside surfaces of food service cart assembly 20 from stainless steel and other easily cleaned materials. Even though the inner most layers of the surfaces are relatively thin, heat transfer from heated compartment 32 to refrigerated compartment 34, and from the ambient environment to refrigerated compartment 34 can be significant. Any such heat loss reduces the thermal efficiency of cart assembly 20. The present invention minimizes heat transfer and improves the thermal efficiency of food service cart assembly 20 by providing structure isolating the inner surfaces of panels 22, 24, 26 and 28 from the outer surfaces thereof, and isolating inner surfaces in refrigerated compartment 34 from inner surfaces in heated compartment 32. FIGS. 8-11 illustrate structures providing improved thermal isolation between compartments 32 and 34, and between interior space 30 and the ambient environment.

In a first embodiment illustrated in FIGS. 8 and 9, a panel 160 is shown. Those skilled in the art will understand that panel 160 could be adapted to function as a top 22, bottom 24, side 26 or door 28 of food service cart assembly 20. However, for reasons that will become clear, panel 160 is especially suited for use as a top panel 22, bottom panel 24 or door panel 28 that spans both heated compartment 32 and refrigerated compartment 34.

Panel 160 includes a first inner panel piece 162 and a second inner panel piece 164 each received in an outer panel piece 166. Outer panel piece 166 includes an outer panel faceplate 168 and flanges 170, 172, 174 and 176 disposed at substantial right angles to outer panel faceplate 168. Flanges 170, 172, 174 and 176 are provided at the perimeter of outer faceplate 168 to define with outer faceplate 168 a thin enclosure having sides and a bottom, with an open top. In the embodiment illustrated in FIG. 8, outer panel piece 166 is lined with insulation material pieces 180, 182, 184 and 186 adjacent each of flanges 170, 172, 174 and 176, respectively. Insulation pieces 180, 182, 184 and 186 line the inner surfaces of the edges of outer panel piece 166. A middle bar 188 of insulation is provided in outer panel piece 166, between opposed insulation pieces 180 and 182.

FIG. 8 illustrates only second inner panel piece 164 installed in outer panel piece 166, while FIG. 9 illustrates first inner panel piece 162 independently. First inner panel piece 162 is installed in outer panel piece 166 similarly to second inner panel piece 164 in completed panel 160. Each of first and second inner panel pieces 162 and 164 is the same, although the width thereof may differ, as will be described subsequently. Each first inner panel piece 162 and second inner panel piece 164 includes a faceplate 200 and flange portions 202, 204, 206 and 208, the flange portions each extending at a 90° angle to faceplate 200. Opposite flanges 202 and 204 define a plurality of legs 210. In the exemplary embodiment illustrated, each such flange 202, 204 has three such legs 210. While flanges 206 and 208 also can be provided with legs 210, and a greater total number of legs 210 can be used, it is preferred to minimize the number of legs 210 on each inner panel piece 162, 164.

First inner panel piece 162 is of a size to fit snugly between insulation pieces 180 and 182, and between insulation piece 184 and middle bar 188. Second inner panel piece 164 fits snugly between insulation pieces 180 and 182 and between middle bar 188 and insulation piece 186. Middle bar 188 thermally separates first inner panel piece 162 from second inner panel piece 164, and insulation pieces 180, 182, 184 and 186 thermally separate first inner panel piece 162 and second inner panel piece 164 from flanges 170, 172, 174 and 176 of outer panel piece 166. The only contact between outer panel piece 166 and either inner panel piece 162 or 164 occurs through legs 210. Since legs 210 are substantially narrow in width, the total area of direct contact between outer panel piece 166 and either first inner panel piece 162 or second inner panel piece 164 is quite small. As a result, direct thermal transfer between outer panel piece 166 and either first inner panel piece 162 or second inner panel piece 164 is substantially reduced. Minimizing the number and size of legs 210 minimizes the total area of physical contact between inside surfaces of panel 160 and outside surfaces thereof.

Panel 160, as illustrated in FIGS. 8 and 9, is particularly suited for use as a top 22, bottom 24 or door 28 by aligning middle bar 188 with divider 76. Inner panel pieces 162 and 164 are then provided exclusively in either heated compartment 32 or refrigerated compartment 34. Thus, inner surfaces of food service cart assembly 20 are discontinuous between heated compartment 32 and refrigerated compartment 34, and heat conduction therebetween is substantially reduced. If panel 160 is used as a side panel 26 extending along only a heated compartment 32 or a refrigerated compartment 34, from one service side 64 or 66 to the other, a single inner panel piece can be used, and middle bar 188 can be eliminated. Hollow spaces of panel 160 are filled with insulation.

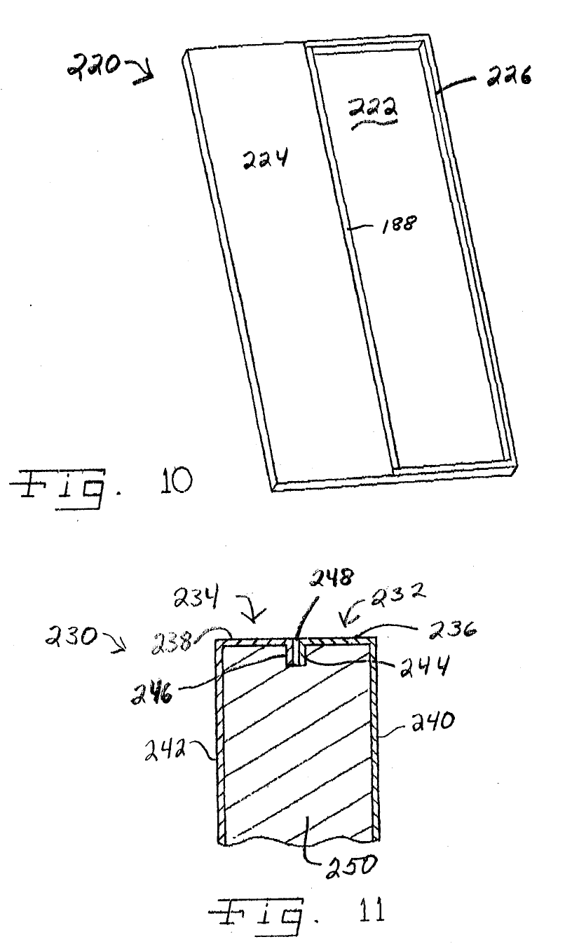

Other structures for panels 22, 24, 26 and 28 of cart assembly 20 also can be used to thermally isolate compartments 32 and 34 from each other and from the ambient environment. FIG. 10 illustrates a panel 220 in which an outer panel piece 222 and one or more inner panel pieces 224 are each a substantially flat, sheet-like structure. A frame 226 of rigid insulating material is provided between outer panel piece 222 and the one or more inner panel piece 224. Depending upon the use of panel 220, one or two inner panel pieces 224 can be provided. If panel 220 is used as a side panel 26 which extends along only a heated compartment 32 or a refrigerated compartment 34, a single inner panel piece 224 can be used. When two inner panel pieces 224 are used, a middle bar 188 is used, and the adjacent inner panel pieces 224 are brought into close proximity, but not into physical contact with each other on middle bar 188. The cavity within frame 226, between outer panel piece 222 and the one or more inner panel pieces 224 can be filled with insulation (not shown).

FIG. 11 illustrates yet another embodiment for a panel 230. Each of an inner panel piece 232 and an outer panel piece 234 includes edge flanges 236 and 238, respectively, surrounding the perimeter of respective faceplates 240 and 242. Edge flanges 236 and 238 include inwardly directed tails 244 and 246, respectively. Inner panel piece 232 and outer panel piece 234 are juxtaposed against each other, and an insulating strip 248 is positioned between tails 244 and 246. The hollow cavity of panel 230 is filed with insulation 250, as can be the hollow cores of any of the other panels described. In panel 230, there is no surface to surface contact of metal portions of inner panel 232 and outer panel 234.

As yet another alternative, one or the other inner panel piece 232 or outer panel piece 234 of panel 230 can be provided as a flat plate, such as those in panel 220 described previously.

It should be understood that also with panel 230 inner panel piece 232 can be constructed of two inner panel pieces. Middle bar 188 of insulation is then used to separate the inner panel pieces to reduce thermal conductivity between inner panel pieces provided in heated compartment 32 and refrigerated compartment 34.

The present invention provides a food service cart assembly having improved thermal isolation between the interior space of the food cart and the ambient environment, between the heated compartment and the refrigerated compartment, and between inner and outer surfaces of the cart. The improved panel structures and improved divider of the cart assembly are simple in design, easy to manufacture and provide a food cart assembly that can be assembled in a cost effective manner. The inner panel pieces can be constructed of stainless steel and other materials that are cleaned easily, without concern for the thermal conductivity of the material.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention, and will enable others skilled in the art to utilize the invention. The claims are to be construed to include alternative embodiments to the extent permitted by the prior art.

Various features of the invention are set forth in the following claims.

What is claimed is:

1. A food service cart assembly comprising:
a plurality of panels including a top, a bottom and sides defining an interior space, said interior space including first and second compartments controllable to different environmental conditions, each of said panels having an inner panel piece and an outer panel piece structured and arranged to limit physical contact between the respective inner panel piece and outer panel piece of each said panel, and panels of said plurality of panels spanning said first and second compartments having discontinuous inner panel pieces; and
a core in said interior space, said core including a shelving system for supporting food trays, and a divider separating said first and second compartments, said divider defining slots for receiving trays, said slots being shaped for retarding the flow of air from one side of said divider to the other side of said divider.

2. The food service cart assembly of claim 1, said divider including first and second wall segments, with at least one of said first and second wall segments being movable relative to the other of said first and second wall segments for pinching a tray disposed in said slot.

3. The food service cart assembly of claim 1, said divider having a first side and a second side and a slot extending from said first side to said second side, said slot having substantial horizontal segments at different elevations and an interconnecting segment between said substantially horizontal segments.

4. The food service cart assembly of claim 1, said divider having a first side and a second side and a slot extending from said first side to said second side, said slot having substantially horizontal first and second segments at a first elevation and a substantially horizontal third segment between said first and second segments, said third segment being at a second elevation different from said first elevation; and first and second interconnecting slot segments between said first segment and said third segment and between said second segment and said third segment, respectively.

5. The food service cart assembly of claim 4, including food trays received in said slots and on said shelving system, said food trays each having a first food compartment and a second food compartment, and a bridge between said compartments, said bridge being shaped to fit in said slot.

6. The food service cart assembly of claim 4, said second elevation being higher than said first elevation.

7. The food service cart assembly of claim 4, said first elevation being higher than said second elevation.

8. The food service cart assembly of claim 4, at least one of said panels including an inner panel piece having an inner panel faceplate and an inner panel flange around said inner panel face plate, and an outer panel piece including an outer panel faceplate and an outer panel flange around said outer panel faceplate, said inner panel piece received telescopically in said outer panel piece, and said inner panel flange having spaced legs engaged against said outer panel faceplate.

9. The food service cart assembly of claim 8, including insulation between said outer panel flange and said inner panel flange.

10. The food service cart assembly of claim 1, at least one of said panels including an inner panel piece having an inner panel faceplate and an inner panel flange around said inner panel face plate, and an outer panel piece including an outer panel faceplate and an outer panel flange around said outer panel faceplate, said inner panel piece received telescopically in said outer panel piece, and said inner panel flange having spaced legs engaged against said outer panel faceplate.

11. The food service cart assembly of claim 1, including insulation between said outer panel flange and said inner panel flange.

12. The food service cart assembly of claim 1, at least one of said panels including an inner panel faceplate and an outer panel faceplate, and a frame of insulation between said inner panel faceplate and said outer panel faceplate.

13. The food service cart assembly of claim 1, at least one of said panels having said inner panel piece and said outer panel piece in juxtaposition, with an insulating strip disposed therebetween.

14. The food service cart assembly of claim 13, said at least one of said panels including at least one of said inner panel piece and said outer panel piece thereof having a faceplate, a flange around said face plate, and an inwardly directed tail from said flange, with said insulating strip disposed on said tail.

15. The food service cart assembly of claim 13, said at least one of said panels including an inner panel piece and an outer panel piece each having a faceplate, a flange around said face plate, and an inwardly directed tail from said flange, with said insulating strip disposed between said tails

16. A core for a food service cart assembly having heated and refrigerated compartments, said core comprising;
a shelving system for supporting food trays;
food trays supported by said shelving system; and
a divider defining slots for receiving trays, said slots adapted for retarding the flow of air from one side of said divider to the other side of said divider.

17. The core for a food service cart assembly of claim 16, said divider including first and second wall segments, with at least one of said first and second wall segments being movable relative to the other of said first and second wall segments for pinching a tray disposed in said slot.

18. The core for a food service cart assembly of claim 16, said divider having a first side and a second side and a slot extending from said first side to said second side, said slot having substantially horizontal segments at different elevations and an interconnecting segment between said substantially horizontal segments.

19. The core for a food service cart assembly of claim 16, said divider having a first side and a second side and a slot extending from said first side to said second side; said slot having substantially horizontal first and second segments at a first elevation and a substantially horizontal third segment between said first and second segments, said third segment being at a second elevation different from said first elevation; and first and second interconnecting segments between said first segment and said third segment and between said second segment and said third segment, respectively.

20. The core for a food service cart assembly of claim 19, including food trays received in said slots and on said shelving system, said food trays each having a first food compartment and a second food compartment, and a bridge between said compartments, said bridge being shaped to fit in said slot.

21. The core for a food service cart assembly of claim 19, said first elevation being higher than said second elevation.

22. The core for a food service cart assembly of claim 19, said second elevation being higher than said first elevation.

23. A panel for at least one of a top, bottom, sides and a door of a food service cart having heated and refrigerated compartments therein, said panel comprising;
an inner panel piece;
an outer panel piece;
said inner panel piece and said outer panel piece structured and arranged to limit direct physical contact between them; and
insulation disposed between adjacent surfaces of said inner panel piece and said outer panel piece.

24. The panel of claim 23, said inner panel piece having an inner panel faceplate and an inner panel flange around said inner panel face plate, said outer panel piece having an outer panel faceplate and an outer panel flange around said outer panel faceplate, said inner panel piece received telescopically in said outer panel piece, and said inner panel flange having spaced legs engaged against said outer panel faceplate.

25. The panel of claim 24, including insulation disposed between said inner panel flange and said outer panel flange.

26. The panel of claim 23, said inner panel piece including a first inner panel piece and a second inner panel piece, each said first inner panel piece and said second inner panel piece having a faceplate and a flange around said faceplate, said outer panel piece having an outer panel faceplate and an outer panel flange around said outer panel faceplate, said first and second inner panel pieces being received telescopically in said outer panel piece, said first and second inner panel piece flanges having spaced legs engaged against said outer panel faceplate and said panel including an insulating bar separating said first and second inner panel pieces.

27. The panel of claim 26, including insulation disposed between said outer panel flange and flanges adjacent thereto of said first and said second inner panel pieces

28. The panel of claim 23, each said inner panel piece and said outer panel piece comprising a plate, and said panel having a frame of rigid insulation disposed between said plates.

29. The panel of claim 28, said inner panel piece including first and second inner panel pieces, and said frame including a middle bar of insulation, said first and second inner panel pieces being spaced from each other at said middle bar.

30. The panel of claim 23, at least one of said inner panel piece and said outer panel piece including a faceplate, a flange surrounding said faceplate, and an inwardly directed tail from said flange; and said insulation disposed on said tail.

31. The panel of claim 23, each said inner panel piece and said outer panel piece including a faceplate, a flange surrounding said faceplate, and an inwardly directed tail from said flange; and said insulation disposed between said tails.

32. The panel of claim 23, said outer panel piece including a faceplate and a flange and said inner panel piece received telescopically within said outer panel flange.

33. The panel of claim 23, one of said outer panel piece and said inner panel piece including a faceplate and a flange, the other of said inner panel piece and said outer panel piece including a faceplate, and said insulation disposed between said flange and said faceplate of said other panel.

34. The panel of claim 33, said other of said inner panel piece and said outer panel piece having first and second faceplates and said panel having a middle bar of insulation, with said first and second faceplates of said other of said inner panel piece and said outer panel piece being spaced from each other at said middle bar.

35. The panel of claim 23, said inner panel piece having a discontinuous inner surface, and said panel having a middle bar of insulating material between said outer panel piece and said inner panel piece discontinuous surface.

36. The panel of claim 35, said inner panel piece including discrete first and second inner panel pieces.

37. A food tray for a food service cart assembly, comprising:
a first food compartment;
a second food compartment; and
a bridge between said first food compartment and said second food compartment, said bridge including;
a first bridge segment and a second bridge segment connected to said first food compartment and said second food compartment, respectively, said first bridge segment and said second bridge segment defining substantially horizontal components at a first elevation;
a third bridge segment at a second elevation different from said first elevation;
a first tying segment interconnecting said first bridge segment and said third bridge segment; and
a second tying segment interconnecting said second bridge segment and said third bridge segment.

38. The food tray of claim 37, said first elevation being higher than said second elevation when said tray is in a level, upright position.

39. The tray of claim 37, said second elevation being higher than said first elevation when said tray is in a level, upright position.
